(19) United States
(12) Patent Application Publication
(10) Pub. No.: US 2006/0179041 A1
(43) Pub. Date: Aug. 10, 2006

(54) Search system and search method

(76) Inventors: Hiroko Ohi, Kokubunji (JP); Osamu Imaichi, Wako (JP); Toru Hisamitsu, Oi (JP); Tomohiro Yasuda, Kokubunji (JP)

Correspondence Address: REED SMITH LLP, Suite 1400, 3110 Fairview Park Drive, Falls Church, VA, 22042, US

(21) Appl. No.: 11/211,729

(22) Filed: Aug. 26, 2005

(30) Foreign Application Priority Data
Feb. 7, 2005 (JP) 2005-029955

(51) Int. Cl. G06F 17/30

(52) U.S. Cl. 707/3

(57) ABSTRACT

Both a first kind of terms and a second kind of terms are designated. A user desires to obtain a relationship between these terms. By employing relations between these terms having been previously stored in a storage in advance, the manner in which these terms are correlated is dynamically displayed, while nodes and edges are gradually increased. In this manner, relations are easily found for concepts (terms) that seem not to be correlated, and an efficient search can also be performed.

### INCORPORATION BY REFERENCE

The present application claims priority from Japanese application JP2005-029955 filed on Feb. 7, 2005, the content of which is hereby incorporated by reference into this application.

### BACKGROUND OF THE INVENTION

1. Field of the Invention

The present invention relates to a search system that supports the construction of a network of terms by employing relevant information, such as keywords and data accumulated in databases, and a search method therefor.

2. Description of the Related Art

Analysis processes for obtaining life science information related to a wide variety of biological species has been developed in parallel around the world, and recently, there has been a dramatic increase in the accumulation, and thus the availability, of data relating to genes and diseases. The opportunity to access and examine pertinent reference documents, rendered possible by the availability of databases wherein enormous amounts of data are deposited, answers the desires of researchers wishing to obtain the latest information in order to confirm the originality of experimental designs or experimental results, and to narrow down drug design targets. For example, a researcher, one who in a year may employ mass spectrometry technology for the detection of around 3000 protein interactions, may search MEDLINE (a document database, in existence since the 1960s, that includes about 13,000,000 cases and is available at the National Library of Medicine in the United States) to determine how original is a detected interaction, and may read documents, obtained to acquire currently available information, and may discuss with others data thus acquired and data obtained as a result of an experiment. Depending on which proteins are studied, several thousands of interactions may previously have been recorded that were obtained through research customarily performed simply to provide information, so that comparing currently available data with data obtained as a result of an experiment and selecting steps to be taken during further experimentation are not an easy task.

Generally, in an information retrieval field based on the use of a search key, such as a keyword, data acutely relevant to the keyword are extracted and are displayed on a screen. An example, in this case, is provided in International Patent Publication No. WO 01/020535, wherein a process is described whereby multiple databases are employed and biological data are searched for using various search methods. [Non-patent Document 1] Singhal, A., Buckley, C. and Mitra, M., “Pivoted Document Length Normalization”, in Proceedings of SIGIR '96, pp. 21-29, 1996

The considered opinion is that, in consequence with the ongoing development of research procedures and like advances in experimental techniques, a huge amount of experimental results will continue to be accumulated. Thus, to obtain new biological knowledge, by discussing currently available information and that based on data acquired through experiments, researchers must expend a great deal of energy in searching for documents, and just how difficult it is to perform an efficient search may be apprehended by examining the example in WO 01/020535. Further, especially when relations between extracted terms are increased, the display of a graph becomes complicated. Therefore, it is preferable that how and from which point a graph is read should be clearly presented, so that the intent of the graph can be easily conveyed.

### SUMMARY OF THE INVENTION

The objective of the present invention is to designate a term group 1 and a term group 2 for which a relation is desired by a user, and to dynamically display the relevance of the term group 1 to the term group 2 by using previously accumulated term relations, while nodes and edges are gradually increased step by step.

A specific configuration is as follows.

A search system according to the present invention comprises:

a first input unit, for entering, as a first query, terms (a first term group) that belong to words in a first category and that a user is interested in;

a second input unit, for entering a second query selected from among words (a second term group) belonging to a second category;

an input unit, for designating a drawing condition; and

a data storage unit, in which a table, wherein relations of all the terms that belong to the first category and the second category and the relevance of the terms are entered is stored in advance. The search system of the present invention also includes:

a calculation unit, for employing this table to correlate the first query with the second query through multiple terms;

a node selector, for permitting a user to select one or more arbitrary nodes from nodes displayed on a screen during the process for coupling the first query with the second query through multiple terms; and

an extraction unit, for extracting a node acutely relevant to the selected node and for coupling the nodes. The search system of the invention further includes: a display unit for displaying, on a screen, a term network that represents the state wherein the first query and the second query are coupled through multiple terms by employing the terms as nodes and the relations of the terms as edges.

The detailed arrangement for searching for the relevance of nodes that are selected by the node selector is as follows.

1. As calculation means, for detecting nodes that can be reached by following a predetermined number of paths and for correlating the detected nodes, the search system includes:

(1) a unit, for displaying all the nodes that can be reached by following a designated number of paths, from the designated node group (selected by the first query, the second query, or selected from among nodes displayed on the screen), and links that are used as these paths, and

(2) a unit, for designating an upper limit for the number of paths (e.g., the default value is one).

2. The search system includes a unit for searching, in the order of their relevances, a designated number of term groups that are relevant to a term group consonant with the designated node group, and for displaying corresponding node groups and the paths between the nodes.

3. The search system includes a unit for designating two arbitrary nodes, previously displayed on a screen and including the first query and the second query, and for generating, as a hypothesis, an edge between the nodes (when an edge is both present and absent in a binary relation database).

The search system of the present invention includes at least one of 1. to 3. described above, and permits a user to freely combine them, as needed, to develop a network.

Terms designated as belonging to the first term group can be those included in a category (hereinafter referred to as a first category) of, for example, compounds, disease names, disease symptoms and protein and gene names, while terms designated as belonging to the second term group can be those included in a category (hereinafter referred to as a second category) of, for example, compounds and protein and gene names. However, so long as there are two term groups a user is interested in, the term groups are not limited to those described above. When information included in documents and a database is visualized as a concept network, the discovery of the biological view by the researchers can be supported, or the relation of terms that is not found by individually examining documents can be obtained and analyzed. A single term, or two or more terms, may be designated for the first term group, and similarly, a single term, or two or more terms, may be designated for the second term group.

As needed, when a word entered in response to a query semantically matches a term registered as belonging to the first category or the second category, a synonym dictionary for terms is employed for a comparison, and conversion means is employed for converting the word into a name included in the first category or the second category.

In this case, the relations of terms that are used as edges for a term network include all the results obtained by analyzing data and documents publicly disclosed on the Web. Data obtained from documents include those extracted manually after being read and those extracted automatically by a mechanical process, such as a natural language process. In a natural language process, the relations of terms is extracted based mainly on co-occurrence and a phrase pattern.

The relevancy of terms is provided while the relation of terms that frequently appear in documents is regarded as important. The calculation of the relevancy of terms is not limited to this method. The search system of the invention may include a unit for employing enhancement lines to connect, along paths coupling the first and second queries, paths along which the sum of the relevances of terms is the highest, and for displaying the paths.

Further, the unit described in 2., which searches, in the order of relevances, the term groups relevant to term groups consonant with the designated node group, employs indexes of terms for a set of documents (a document-term index that indicates how many times which document includes which term, and a term-document index that indicates how many times which term is included in which document). Then, a relevance providing search unit employs the given term group and the term-document index to search for a document that has high relevancy, while a designated number of terms is the upper limit. Further, the relevance providing search unit can employ the most relevant document group that is found and the document-term index and can search for a more relevant term while a designated number is used as the upper limit. Or, during the search for a relevant document, a parameter can be designated for a maximum number of the most relevant documents to be used.

Further, according to this search system, when, as needed, an edge connecting term is clicked on, the name of a magazine, the origin, from which the relations of the terms is extracted, or a sentence, an abstract or a database from which information is extracted, can be presented. In addition, when a node is clicked on, information associated with an individual term can be presented.

By changing the setup of a search condition, the network of terms may be interactively re-displayed.

Moreover, when the editing function of a screen display system is additionally provided, the inappropriate linking of terms, i.e., edges, or an inappropriate term, can be removed, or the linking of terms, or a term, that seems insufficient can be added to reconstruct the network.

According to the present invention, when many binary relations or multinomial relations are collected from documents and a database, only that information that is necessary and important can be arranged and displayed as a graph, so that an enormous amount of complicated information can be efficiently presented and well-organized, in accordance with the intent of a user. Further, for a concept or a term that is regarded as non-relevant, it is easy to find a new relevancy.

### BRIEF DESCRIPTION OF THE DRAWINGS

FIG. 1 is a diagram showing the configuration of a search system according to the present invention;

FIG. 2 is a diagram showing a database used by the search system;

FIG. 3 is a diagram showing an example user interface;

FIG. 4 is a diagram showing the general configuration of a processor in a server computer;

FIG. 5 is a diagram for explaining the processing for simultaneously coupling terms for a first query and a second query using multiple terms;

FIG. 6 is a diagram showing the initial stage of the step by step processing for developing terms for the first query and the second query;

FIG. 7 is a diagram for explaining the processing for searching for a node that can be reached by following a predetermined number of paths;

FIG. 8 is a diagram for explaining the processing for searching for a designated number of highly relevant terms;

FIG. 9 is a diagram for explaining the processing for the generation of edges as an assumption;

FIG. 10 is a diagram showing example data for a document-term index and a term-document index;

FIG. 11 is a diagram showing example data for a binary relation extracted based on a phrase pattern;

FIGS. 12A and 12B are diagrams showing examples in which nodes having high relevances are displayed;

FIG. 13 is a diagram for explaining the calculation processing for searching for a designated number of terms having a high relevance and extracting corresponding nodes;

FIG. 14 is a diagram for explaining the calculation processing for detecting all the nodes that can be reached by following a predetermined number of paths and for correlating the nodes;

FIGS. 15A and 15B are diagrams showing examples for the generation of edges as an assumption;

FIG. 16 is a diagram for explaining the calculation processing for the generation of edges as an assumption; and

FIGS. 17A to 17C are diagrams showing one embodiment for the coupling and the display of nodes using a dominant concept.

### DETAILED DESCRIPTION OF THE EMBODIMENT

The preferred embodiment of the present invention will now be described in detail while referring to the accompanying drawings.

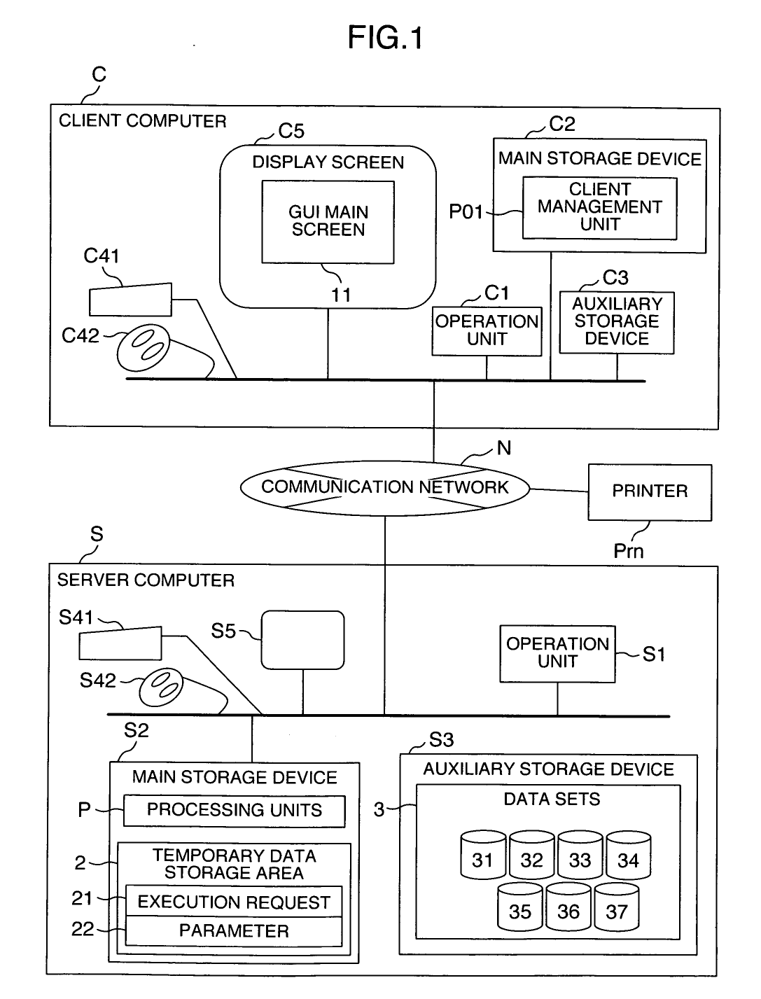

A configuration for the present invention is shown in FIG. 1. This configuration comprises: a client computer C, a server computer S and a network N. A configuration wherein the client computer and the server computer are identical and a network is not always employed can also be employed. As needed, a printer Prn is employed to print search results.

The client computer C includes: an operation unit C1, a main storage device C2, an auxiliary storage device C3, a keyboard C41 and a mouse C42, which are input units C4, and a display unit C5. In the main storage device C2, a client management unit P01 is operated to display a GUI (Graphical User Interface) main screen 11 on the display unit C5, and to provide overall control for the processing performed by the client computer C.

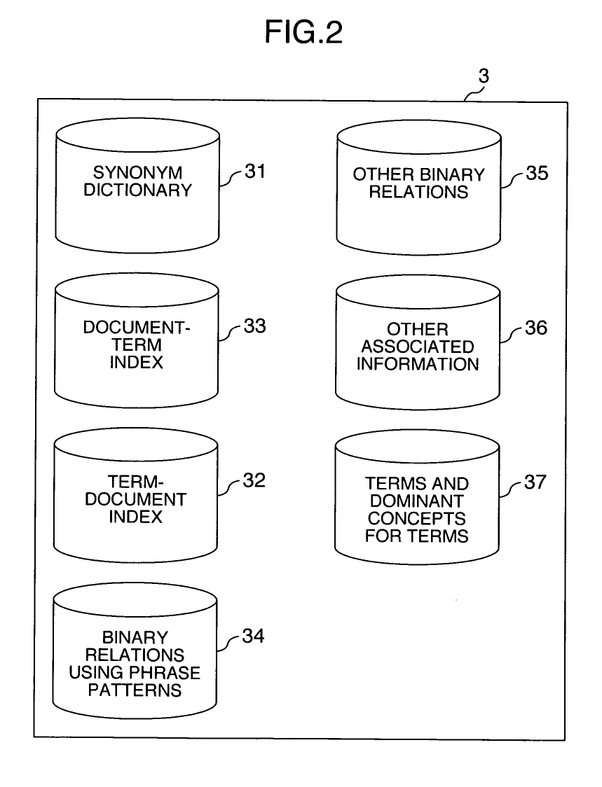

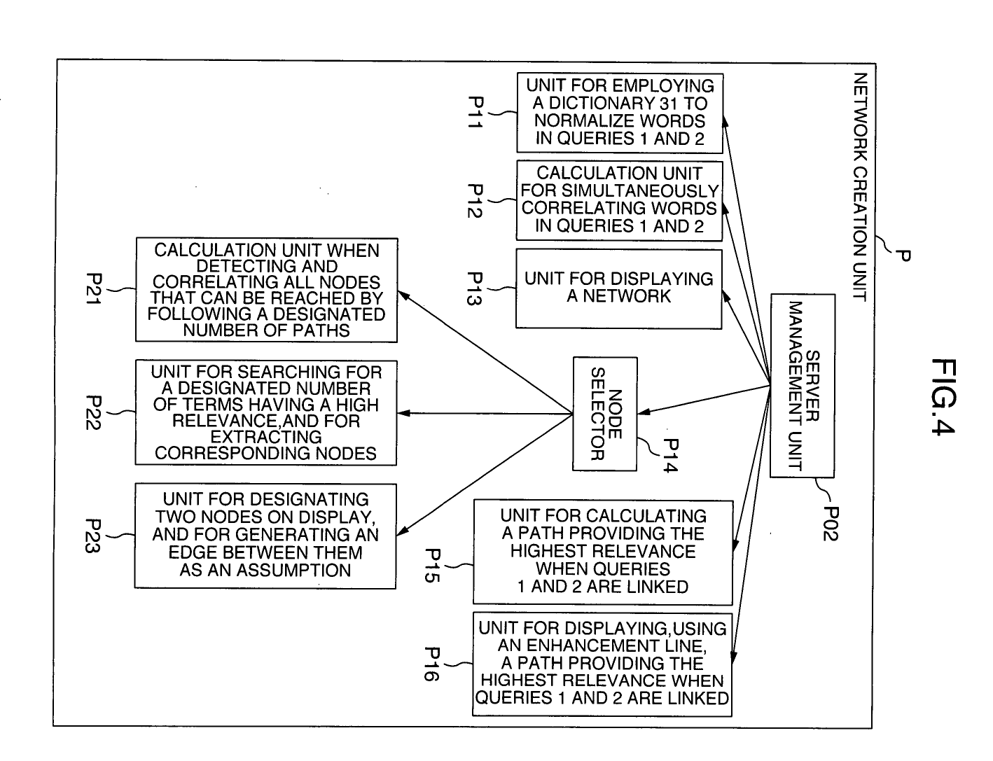

Likewise, the server computer S includes an operation unit S1, a main memory device S2, an auxiliary storage device S3, a keyboard S41, a mouse S42 and a display unit S5. In the main storage device S2 of the server computer S, processing units P, required for carrying out the present invention, are operated (details of these units are shown in FIG. 4). For these processing units P, a search request 21 and a parameter 22 are dynamically or fixedly stored as temporary data in a temporary data storage area 2 of the main storage device S2. In the auxiliary storage device S3 of the server computer S, data (the details of which are shown in FIG. 2) are stored that are required for carrying out the present invention.

Data required to carry out the present invention are shown in FIG. 2. The data include: a synonym dictionary 31, for converting a term designated in a query into a term that semantically matches those in the category; a term-document index 32, for indicating how many times which term is included in which document; a document-term index 33, for indicating how many times which document includes which term; binary relation data 34, for genes and proteins that are automatically extracted, in advance, from documents manually or by using a phrase pattern; other binary relation data 35, which are collected from a database; data 36, which are obtained by collecting other associated information; and data 37, which are obtained by collecting terms and the dominant concepts of terms.

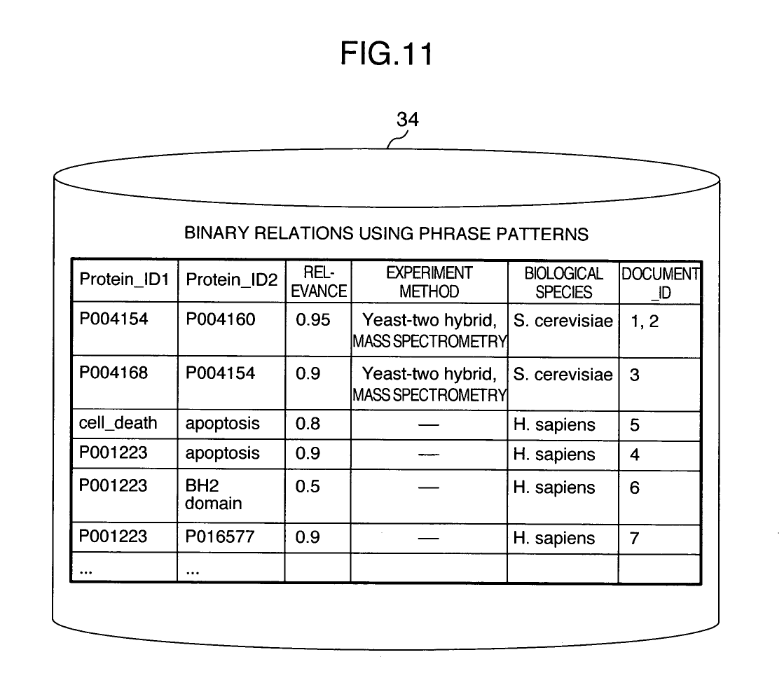

An example binary relation and an example multinomial relation extracted by using phrase patterns, as indicated by 34 in FIG. 2, are shown in FIG. 11. The binary relation and the multinomial relation are collected from PubMed (http://www.ncbi.nlm.nih.gov/entrez/query.fcgi) and a variety of journals. Phrase patterns, “concept 1 binds concept 2” and “concept 1 interacts with concept 2”, for example, can be employed, and when the individual sentences of a document are analyzed and these phase patterns appear, it is assumed that a binary relation or a multinomial relation exists between the concepts, and this relation is registered in a database. Further, the relevance of the individual concepts is calculated in accordance with the frequency of the binary relations or the multinomial relations, and is provided for each relation.

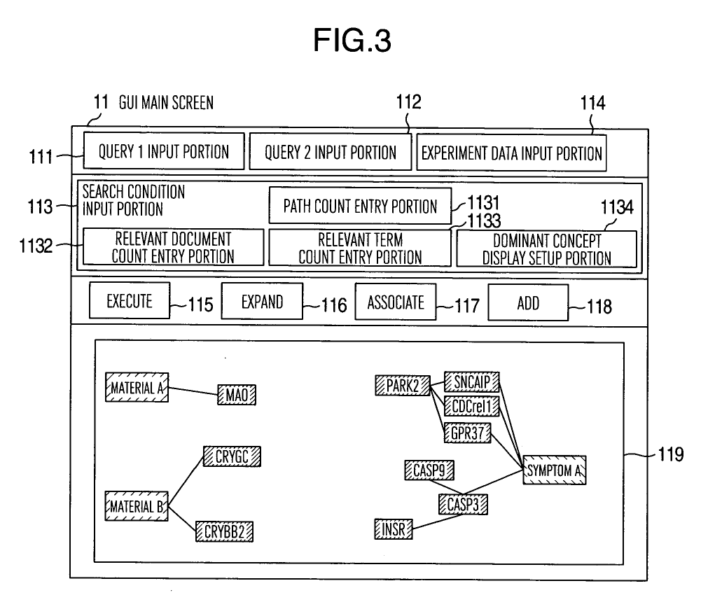

An example user interface for setting up a search request, for example, is shown in FIG. 3. The GUI main screen 11 includes a query 1 input portion 111, a query 2 input portion 112, a search condition input portion 113, an experimental data input portion 114, an execute button 115, an expand button 116, an associate button 117, an add button 118 and a network display portion 119. A first category to be entered for a query 1 is one for a disease name, a symptom, a protein name, a gene name, a compound name or a gene/protein function, and a second category to be entered for a query 2 is one for a compound name, a protein name of a gene name.

FIG. 4 is a diagram showing the configuration for the processing units P of the server computer S shown in FIG. 1. A server management unit P02 controls the processing performed by the server computer S, and directly calls: a unit P11, which employs a dictionary 31 to normalize terms in the query 1 and the query 2; a calculation unit P12, which correlates at one time the term in the query 1 with the term in the query 2; a unit P13, which displays a network; a node selector P14; a unit P15, which, when the queries 1 and 2 have already been coupled, calculates a path along which the relevance of the queries 1 and 2 is the highest; and a unit P16, which, when the queries 1 and 2 have already been coupled, displays the path indicating the highest relevance by using an enhancement line. The node selector P14 further includes: a calculation unit P21, which searches for all the nodes that can be reached by following designated paths and searches for edges used to correlate these nodes, and which correlates these nodes by using the edges; a calculation unit P22, which searches for a designated number of terms that are highly relevant to selected nodes, searches for edges used to correlate these nodes with corresponding nodes and correlates these nodes by using the edges; and a calculation unit P23, which designates two nodes on the display and generates, as an assumption, an edge between the nodes. In this case, the node selector P14 includes (1) the calculation unit P21, which searches for nodes by following a designated number of paths and for edges used to correlate those nodes, and correlates the obtained nodes; (2) the calculation unit P22, which searches for a designated number of terms relevant to a selected node, searches for edges to correlate the nodes and correlates the nodes by using the edges; and (3) the calculation unit P23, which, as an assumption, generates an edge between two designated nodes. However, in accordance with the convenience that is requested, the node selector P14 must only include one of these calculation units.

The relation of the search condition input portion 113 in FIG. 3 and the node selector P14 in FIG. 4 will now be described. A path count entry portion 1131 of the search condition input portion 113 (FIG. 3) is employed by the calculation unit P21 (FIG. 4). The calculation unit P21 searches for all the nodes that can be reached by following a number of paths, the default count of which is “one”, designated in the path count entry portion 1131. When a value exceeding the upper limit of the path count is entered, a display indicating a value exceeding the upper limit is presented, and a relevant document count entry portion 1132 and a relevant term count entry portion 1133 are employed by the calculation unit P22 (FIG. 4). A parameter indicating the maximum number of documents relevant to a selected term that is to be used is designated in the relevant document count entry portion 1132, and the calculation unit P22 searches for relevant terms using a number of terms designated in the relevant term count entry portion 1133.

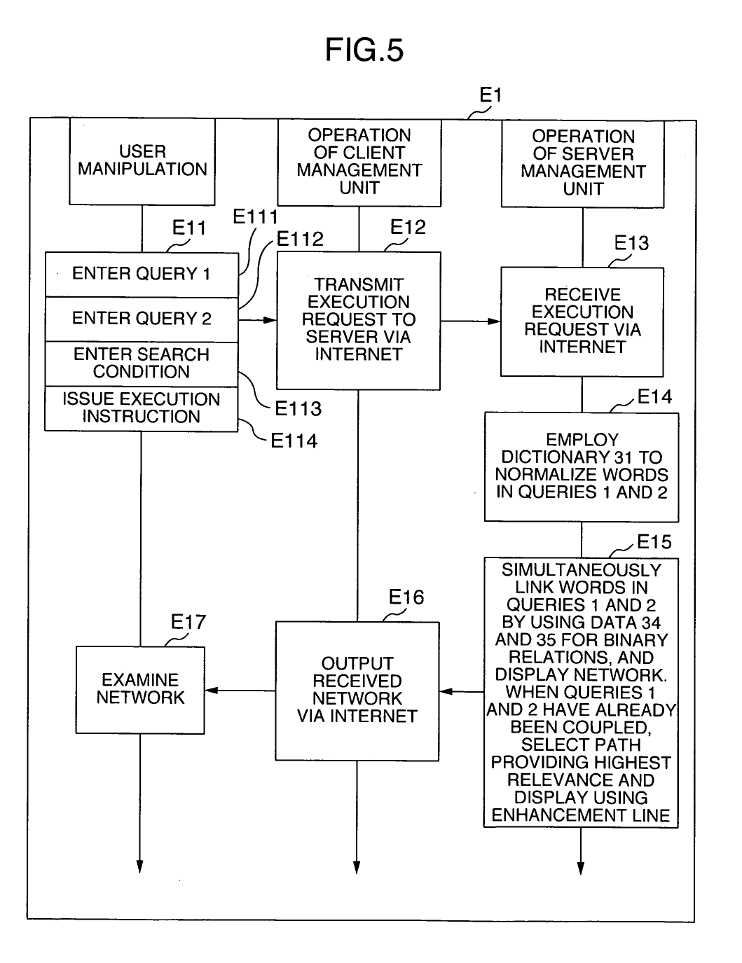

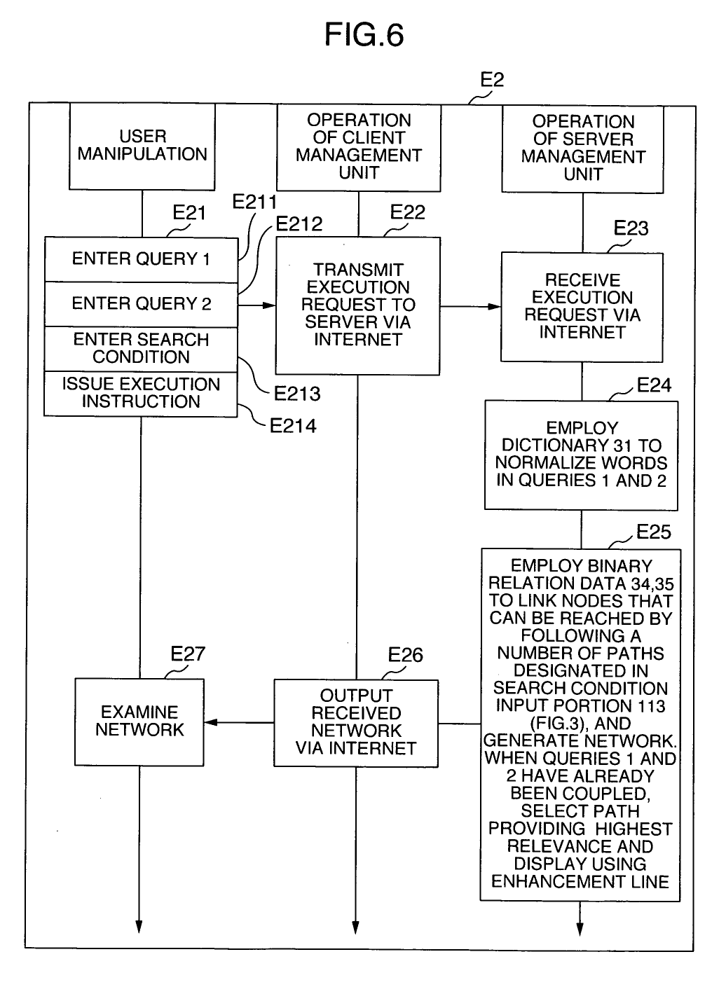

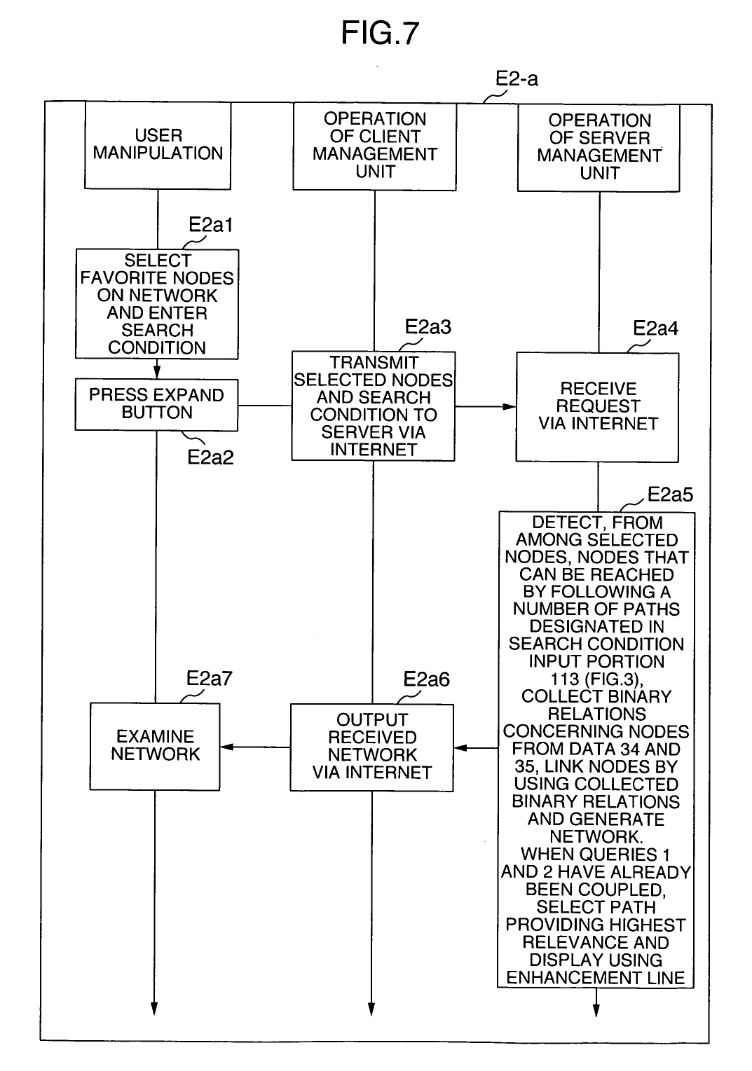

Network processing E1 and E2 will now be described while referring to FIGS. 5, 6, 7, 8 and 9. Since the processing is roughly classified into two types, depending on the user's interest, the example processing will be explained separately for E1 and E2. The processing E1 is an example wherein, as shown in E15 in FIG. 5, terms designated in the query 1 and the query 2 are simultaneously linked, and the results are displayed on a network. The processing E2 in FIG. 6 is an example wherein, as shown in E25, a network is gradually extended, step by step (nodes and edges are increased). Since the processing succeeding E2 is further divided into three types, depending on user manipulation, these processes will be explained as E2-a, E2-b and E2-c in FIGS. 7 to 9. As for the processes E2-a, E2-b and E2-c, the same process can be either repeated an arbitrary number of times or can be freely combined and performed, in accordance with the user's interest. The process E2-a is an example, as indicated by E2a5, wherein in order to extend a network all the nodes that can be reached by following the number of paths that is designated in advance (corresponds to P21 in FIG. 4). The process E2-b is an example wherein, as indicated by E2b5, a predesignated number of terms having high relevance are displayed (corresponds to P22 in FIG. 4). The process E2-c is an example wherein, as indicated by E2c5, two nodes, already displayed, are designated, and as an assumption, an edge is generated between the nodes (corresponding to P23 in FIG. 4).

In FIG. 5, the left line represents the processing performed as a result of user manipulations, the middle line represents the processing performed by the client computer C, and the right line represents the processing performed by the server computer S. First, as the user manipulations, the query 1 and the query 2 are respectively entered in the query 1 input portion 111 (FIG. 3) and the query 2 input portion 112 (FIG. 3) on the main screen 11 (FIG. 3) (E111 and E112). Then, a search condition is entered in the search condition input portion 113 (FIG. 3) (E113), and the execute button 115 (FIG. 3) is pressed to issue an execution instruction (E114).

Upon receiving the instruction, the client management unit P01 transmits the queries 1 and 2, for example, and the search condition via the communication network N (FIG. 1), such as a LAN or the Internet, to the server management unit P02 that is operated by the server computer S (E12). When the client computer C and the server computer S are identical, the queries 1 and 2 and the search condition are transmitted via inter-process communication means. Based on the received work request, the server management unit P02 normalizes words in the queries 1 and 2 by employing the dictionary 31 (E14 in FIG. 5; P11 in FIG. 4), collects, from the data 34 and 35, binary relations concerning the normalized words, simultaneously links the words by employing the collected binary relations (P12 in FIG. 4), and generates a network (E15). In this case, when the queries 1 and 2 have already been coupled, a path along which the relevance is the highest is calculated and selected (P15 in FIG. 4). The relevance between the terms can, for example, be the frequency at which the binary relation appears in a document. As a method available for the calculation of a path providing the highest relevance, [1] using a score representing the relevance of terms having been employed, a function being the total score/(the number of edgesˆ1.1), or [2] selecting a function including the other score and edges, a pass being high scores between passes, and the queries 1, 2 being selected using Dijkstra's Algorithm or PERT (Program Evaluation and Review Technique). The path, via the network or the inter-process communication, providing the highest relevance is transmitted to the client management unit P01, and the client management unit P01 displays the obtained network on the network display unit 119 (E16 in FIG. 5; P13 in FIG. 4). When the queries 1 and 2 have already been linked, the paths along which the relevance of the queries 1 and 2 is the highest is displayed using an enhancement line (P16 in FIG. 4). Thereafter, a user can examine the displayed network (E17).

The processing E2 in FIG. 6 will now be described. First, as user manipulations, the query 1 and the query 2 are respectively entered in the query 1 input portion 111 (FIG. 3) and the query 2 input portion 112 (FIG. 3) on the main screen 11 (FIG. 3) (E211 and E212). Then, a search condition is entered in the search condition input portion 113 (FIG. 3) (E213), and the expand button 116 (FIG. 3) is pressed to enter an execution instruction (E214).

Upon receiving the instruction, the client management unit P01 transmits the queries 1 and 2 and the search condition, for example, via the communication network N (FIG. 1), such as a LAN or the Internet, to the server management unit P02, which is operated by the server computer S (E22). When the client computer C and the server computer S are identical, the queries 1 and 2 and the search condition are transmitted via inter-process communication means. Based on a received work request, the server management unit P02 then normalizes the words in the queries 1 and 2 by employing the dictionary 31 (E24 in FIG. 6; P11 in FIG. 4), collects, from the data 34 and 35, binary relations concerning the collected words, employs the collected binary relations to link nodes that can be reached by following a number of paths, designated in the search condition input portion 113 (FIG. 3) (P21 in FIG. 4), and generates a network (E25). In this case, when the queries 1 and 2 have already been linked, a path along which the relevance is the highest is calculated and selected (P15 in FIG. 4). The obtained path is again transmitted to the client management unit P01, via the network or inter-process communication, and the client management unit P01 displays the obtained network on the network display unit 119 (E26; P13 in FIG. 4). Then, sequentially, the path along which the relevance of the queries 1 and 2 is the highest can be displayed using an enhancement line (P16 in FIG. 4). Thereafter, a user can examine the displayed network (E27).

A user can also employ a screen editing function to remove an inappropriate edge (a line connecting terms) or an inappropriate term from a network that has been drawn, or can add an edge or a term to facilitate the recalculation of the network.

When the amount of relevant information for genes and proteins is insufficient for a target biological species, the affinity of the array with information for another biological species can be employed to construct a network of terms in the same manner.

While referring to FIG. 7, an explanation will now be given for the process E2-a, during which, to expand the network, all the nodes that can be reached by following a predesignated number of paths are displayed. This process E2-a is performed following the processes E2, E2-b and E2-c, and a network is interactively displayed by changing a search condition. First, nodes a user is interested in are selected from a network that has already been displayed, and a search condition (the number of paths to be displayed) is entered (E2a1; P14 in FIG. 4). By clicking on the expand button 116, the selected nodes and the search condition are transmitted, via the communication network N, to the server management unit P02 (E2a3). Based on a received work request (E2a4), the server management unit P02 collects binary relations, concerning words selected from the data 34 and 35, employs the collected binary relations to link nodes that can be reached by following a number of paths designated in the search condition input portion 113 (FIG. 3) (P21 in FIG. 4), and generates a network (E2a5). In this case, when the queries 1 and 2 have already been linked, a path along which the relevance is the highest is calculated and selected (P15 in FIG. 4). The obtained path is then transmitted again, via the network or via inter-process communication, to the client management unit P01 (E2a6), and the client management unit P01 displays the obtained network on the network display unit 119 (P13 in FIG. 4). When the queries 1 and 2 have already been coupled, a path providing the highest relevance for the queries 1 and 2 is displayed using an enhancement line (P16 in FIG. 4). Thereafter, a user may examine the displayed network (E2a7), and since the enhancement line is employed, the user can easily identify the path on the display.

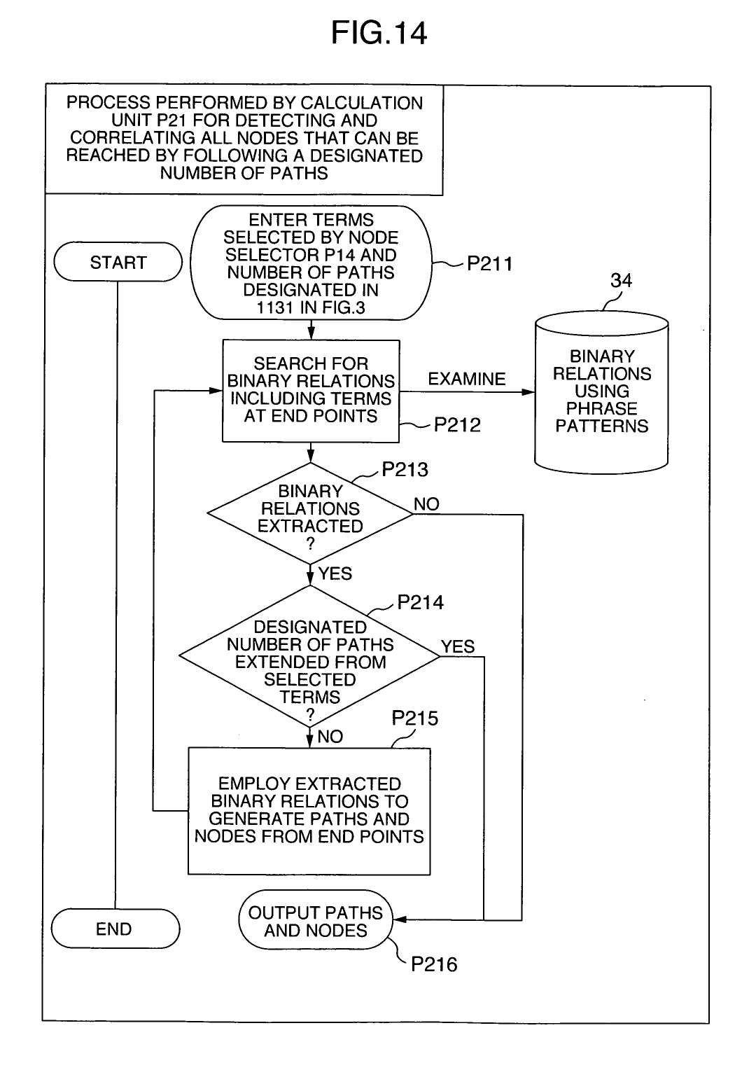

FIG. 14 is a detailed diagram showing the processing performed by the calculation unit P21, which detects and correlates all the nodes that can be reached by following a designated number of paths. The terms are those selected by the node selector P14, and the number of paths is the value entered in the path count entry portion 1131 (FIG. 3). With designated nodes being employed as end points, binary relations, including those of terms at the end points, are searched by referring to the binary relation databases 34 and 35 (P212). When a binary relation is extracted, a check is performed to determine whether the designated number of paths have already been extended from the selected term (P213 and P214). When the designated number of paths have not been extended, the extracted binary relation data are employed to generate paths and nodes from the end points (P215) (when a plurality of terms have been selected by the node selector P14, paths and nodes are generated only for the end point to which the designated number of paths are extended). Then, program control returns to the process at P212, and binary relations, including those of terms at the end points, are searched for. When binary relations have not been extracted, or when the designated number of paths have been extended from the selected term, program control is shifted to P216 and paths and nodes are output. Since the operation for gradually extending the paths is performed in this manner, the paths can be arranged in consonance with the interest of the user.

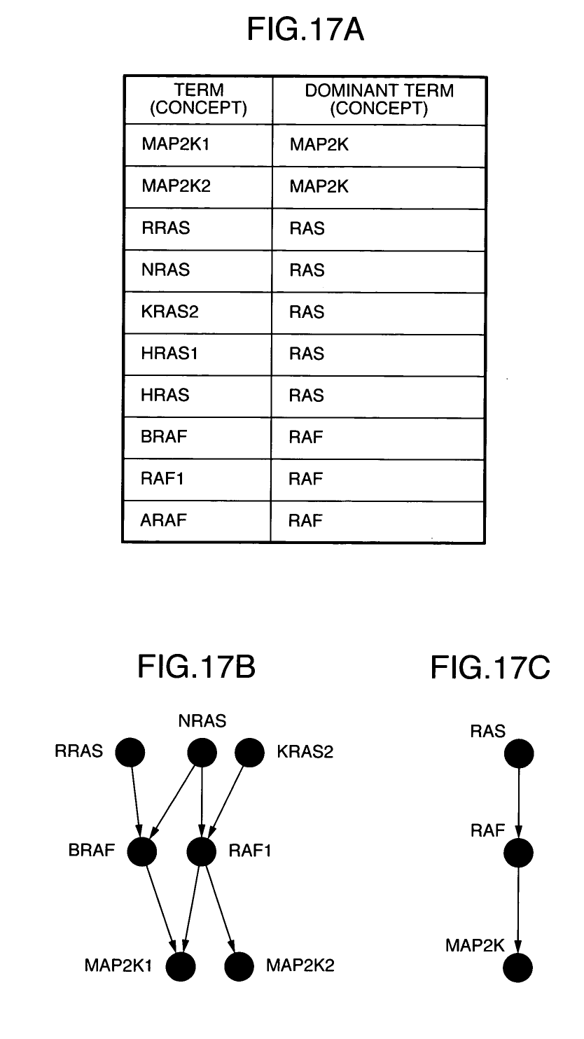

A user can draw a higher hierarchy term network designated by a dominant concept display setup portion 1134 in FIG. 3. This example is shown in FIGS. 17A to 17C. In data shown in FIG. 17A, a relation of the terms and the dominant concept is shown. When a complicated network in FIG. 17B is drawn, based on a dominant concept (terms), by employing the data in FIG. 17A, a network shown in FIG. 17C can be obtained that is easily understood by a user. Drawing based on the dominant concept is also performed in order to moderate a drawing condition. For example, when the correlation only of RRAS, BRAF and MAP2K1 is pointed out in the network in FIG. 17A, a correlation relative to MAP2K2 can not be extracted from RRAS. However, for the drawing of the dominant concepts, RAS and RAF, and RAF and MAP2K are correlated, based on the information for dominant concepts, so that RAS and MAP2K are also correlated.

### SECOND EMBODIMENT

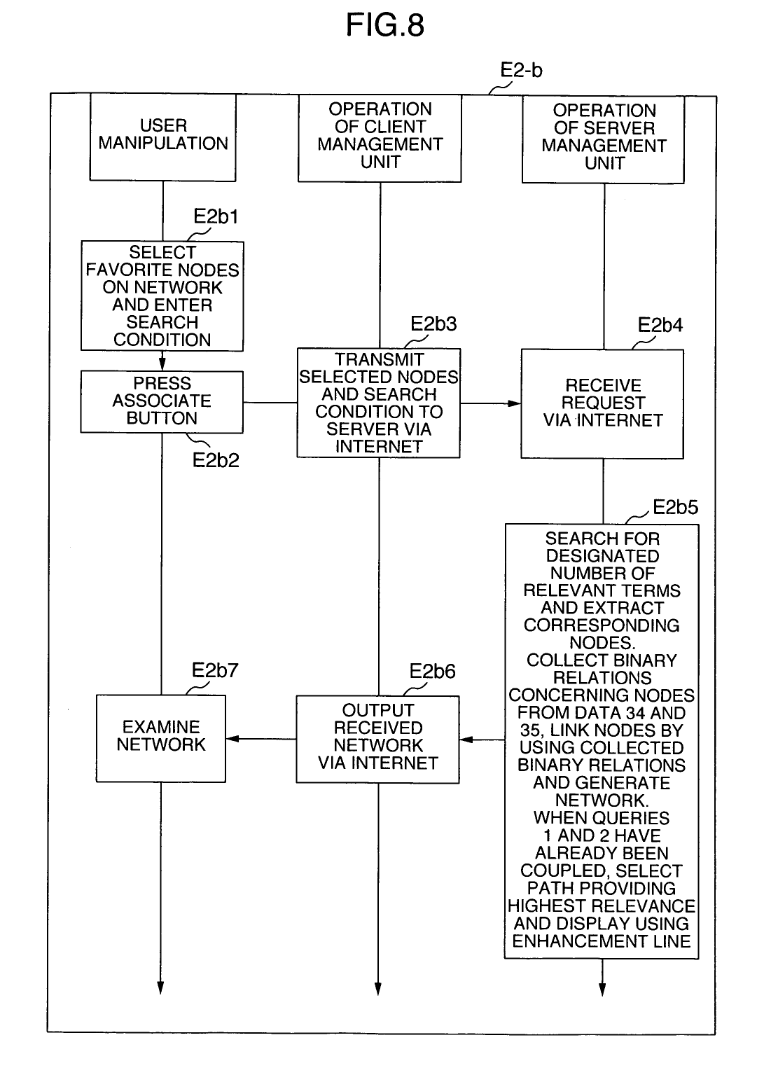

While referring to FIG. 8, an explanation will now be given for the process E2-b, wherein a predesignated number of relevant terms are displayed to develop a network. The process E2-b is performed following the processes E2, E2-a and E2-c. But first, nodes a user is interested in are selected on a displayed network, and search conditions (the number of terms to be displayed and the number of relevant documents) are entered (E2b1; P14 in FIG. 4). By clicking on the associate button 117, the selected nodes and the search conditions are transmitted via the communication network N to the server management unit P02 (E2b3). Then, based on a received work request (E2b4), the server management unit P02 searches for a designated number of relevant terms and extracts corresponding nodes (E2b5; P22 in FIG. 4), and collects binary relations concerning the nodes from the data 34 and 35, couples the nodes by using the collected binary relations and generates a network.

When, in this case, the queries 1 and 2 have been linked, a path providing the highest relevance is calculated and selected (P15 in FIG. 4). The thus obtained path is then again transmitted via the network, or via inter-process communication, to the client management unit P01 (E2b6), and the client management unit P01 displays the obtained network on the network display unit 119 (P13 in FIG. 4). When the queries 1 and 2 have already been coupled, the path along which the relevance of the queries 1 and 2 is the highest is displayed using an enhancement line (P16 in FIG. 4). Thereafter, the user may examine the displayed network (E2b7).

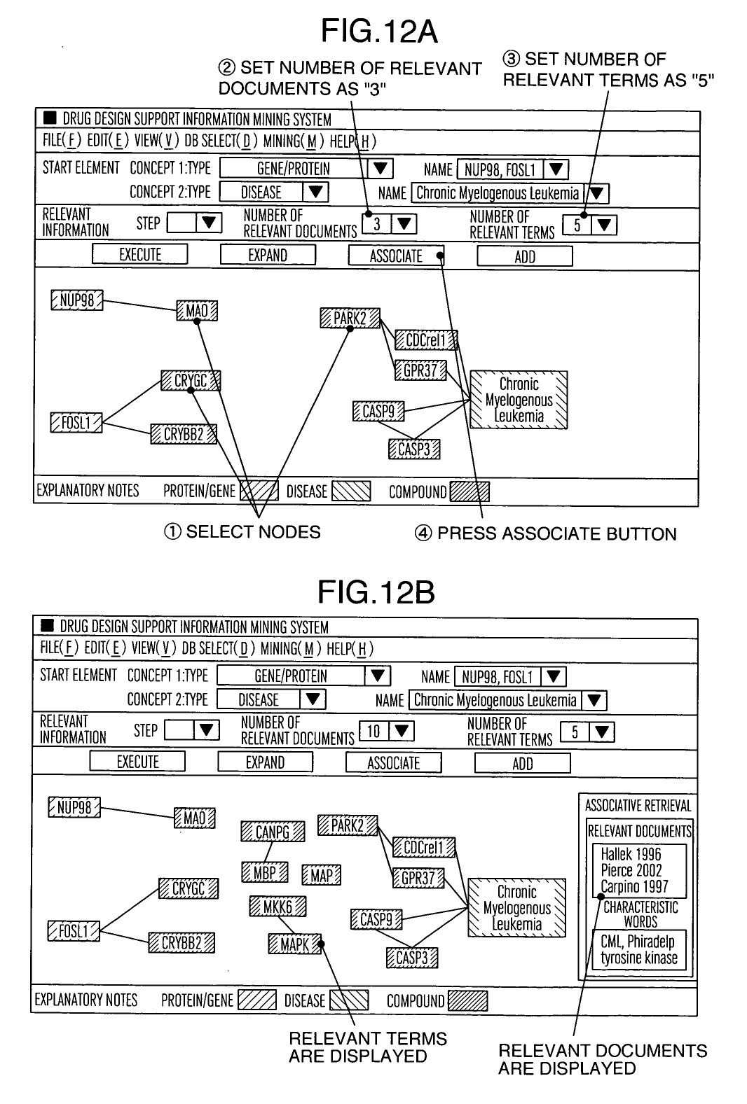

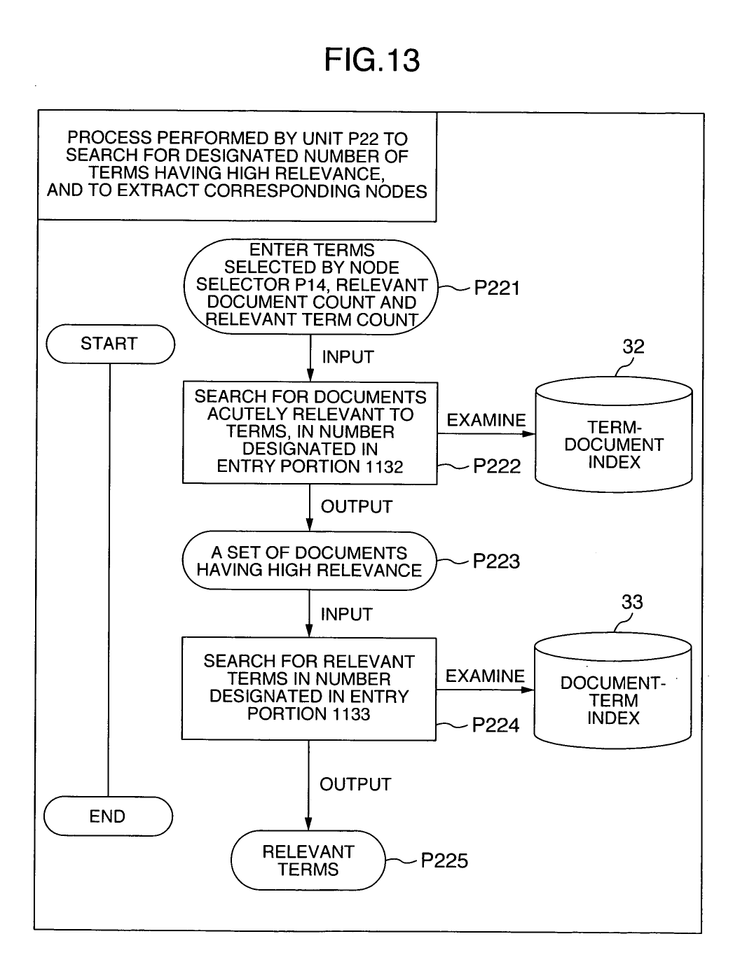

FIG. 13 is a detailed diagram showing the process performed by the unit P22. Nodes designated by the node selector P14, the number of relevant documents and the number of relevant terms are entered (P221). In FIG. 12A, gene names MAO, CRYGC and PARK2 are selected, and a condition is designated whereby to collect three documents acutely relevant to the terms and to extract five relevant terms from the documents.

Then, by referring to the term-document index 32 (data indicating how many times which term is included in which document), the relevance providing search unit searches for a set of documents relevant to a term group corresponding to a designated node group, while the designated number of documents, beginning with the document having the highest relevance, is defined as the upper search limit (P222).

In this case, the relevance providing search unit may search for the dominant concept of the designated term group by employing the data in FIG. 17A, and may search for a set of documents relevant to terms including the dominant concept by employing the term-document index 32 (data indicating how many times which term is included in which document), while the designated number of documents, beginning with the document having the highest relevance, is defined as the upper search limit.

An arbitrary method for calculating the relevance may be employed. For example, the well known tf*idf method can be used to obtain the relevance between a word and a document. The tf*idf method employs, as a weight, tf(t, d)idf(t), which is a product of tf(t, d), the frequency (term frequency) of a term t that appears in a document d, and a scale called the IDF (inverse document frequency), which represents the number of documents wherein the term t appears.

$$idf ( t ) = log \frac{T}{df ( t )} + 1 \qquad [ Ex . 1 ]$$

In expression 1, T denotes the total number of documents, and df(t) denotes the number of documents wherein the term t appears. The SMART scale method (Singhal, A., Duckley, C. and Mitra, M., “Pivoted Document Length Normalization”, in Proceedings of SIGIR' 96, pp. 21-29, 1996), which constitutes the improved tf*idf method, can also be employed. When multiple terms are selected, the relevance is obtained by aggregating (e.g., adding) the weights of all the selected terms.

Furthermore, while the designated number of terms is regarded as the upper limit, the relevance providing search unit searches for relevant terms by employing the set of the most relevant documents obtained by the search (P223) and the document-term index 32 (data indicating how many times which document includes which term) (P224). Then, the terms that are found are displayed as terms relevant to the designated terms (FIG. 12B).

Since a graph is displayed by narrowing it down to the most relevant terms, an increase in the amount of information and in the complication of a graph are prevented, and only needed information is provided for a user to read.

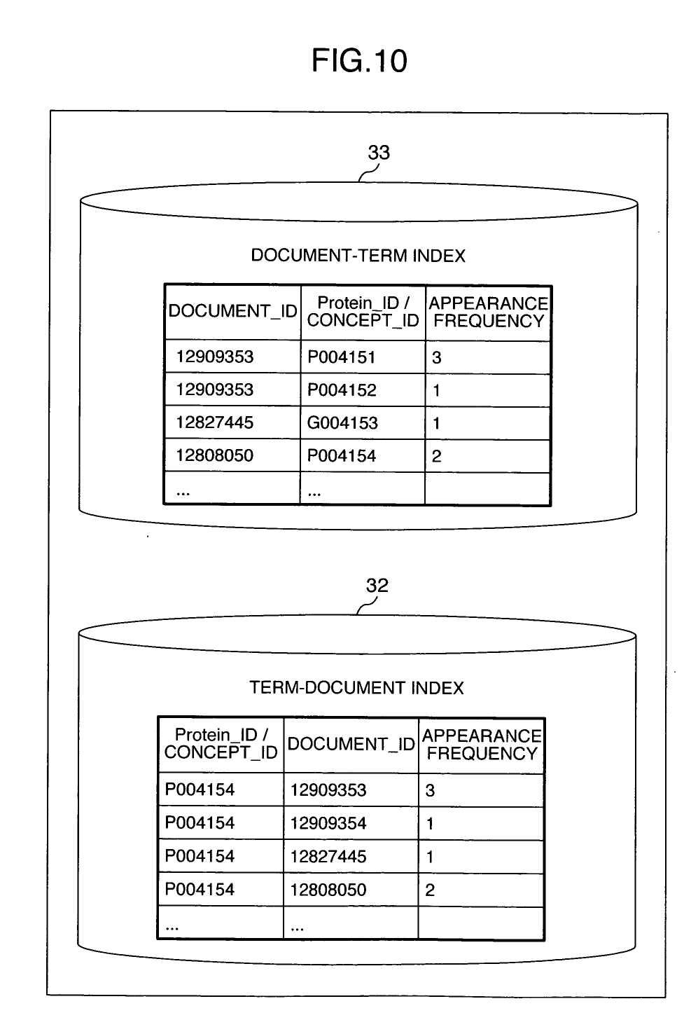

Example data for words and document information are shown in FIG. 10. The document-term index 33 includes information related to how many times which document includes which term, and the term-document index 32 includes information related to how many times which term is included in which document.

These indexes may be constructed for individual concepts, such as compounds, diseases and proteins.

When an index is constructed by mixing concepts, the relevance providing search unit employs the term-document index 33 to search for documents having a higher relevance relative to the term group selected by the user, while the designated number of documents is regarded as the upper limit. Further, the relevance providing search unit employs the obtained relevant documents and the term-document index 32 to search for terms having a higher relevance, while the designated number of terms is regarded as the upper limit.

When an index is separately provided for each concept, the relevance providing search unit employs the term-document index 32 to search for documents having the highest relevance relative to the term group selected by the user, while the number of documents designated for each concept is regarded as the upper limit. Then, the relevance providing search unit employs the relevant documents that have been found and the document-term index 33 to search for terms having a higher relevance, while the number of terms designated for each concept is regarded as the upper limit.

### THIRD EMBODIMENT

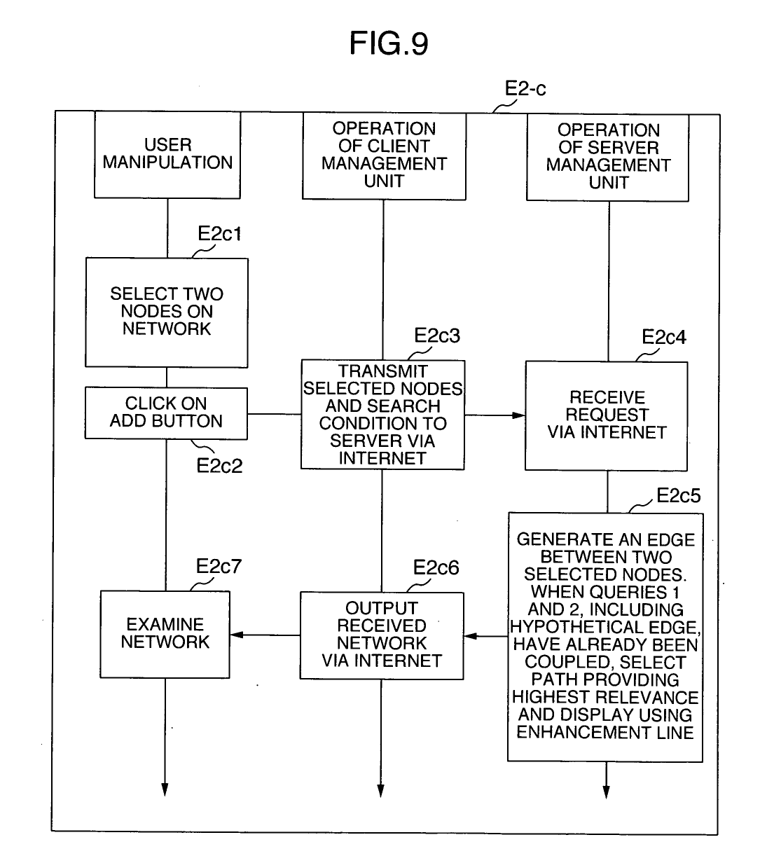

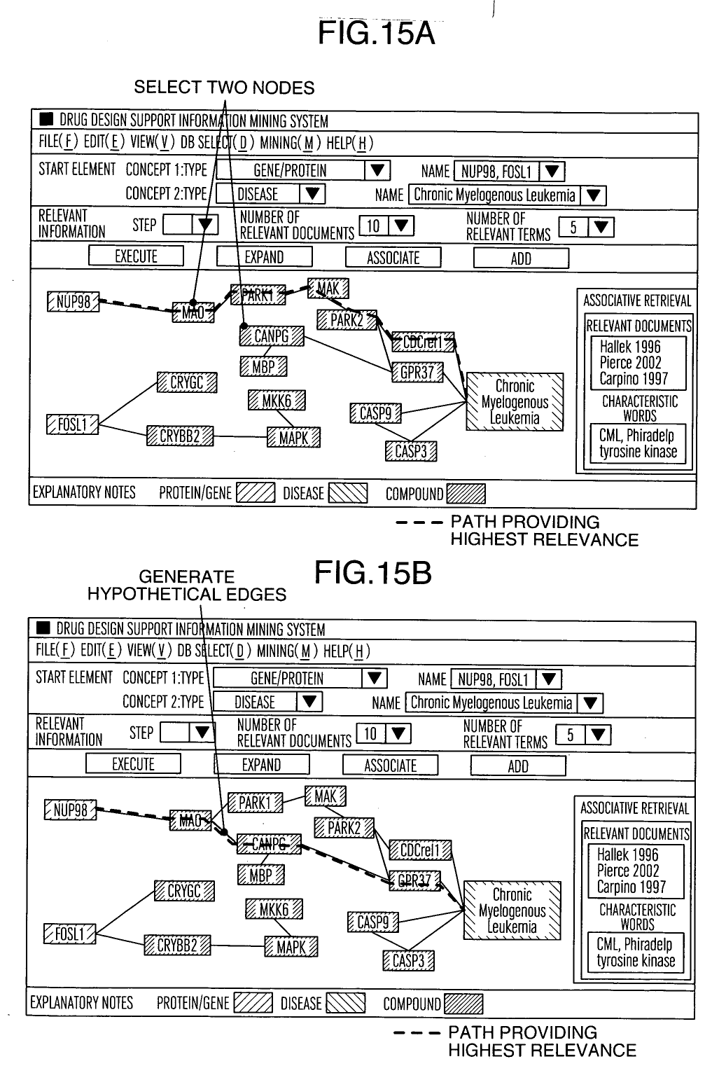

While referring to FIG. 9, an explanation will now be given for the process E2-c, wherein two nodes that have already been displayed are designated and an edge is generated, as an assumption, between the nodes, and the process E2-c is performed following the processes E2, E2-a and E2-b. First, two nodes in a network on the display are selected (E2c1), and the add button 118 is clicked on (a specific example is shown in FIG. 15A), and a request is transmitted via the Internet to a server (E2c3). Upon receiving the request via the Internet (E2c4), the server generates an edge between the two selected nodes as an assumption (E2c5). At this time, when the queries 1 and 2 have already been coupled and while including the edge generated as the generated assumption, a path providing the highest relevance is calculated and selected (a specific example is shown in FIG. 15B). The relevance of the hypothetical edge may be defined as a default value and a received network may be output via the Internet (E2c6), while the client management unit P01 displays the obtained network on the network display unit 119. When the queries 1 and 2 have already been linked together, the path along which the relevance of the queries 1 and 2 is the highest is displayed by using an enhancement line. Thereafter, the user examines the network (E2c7).

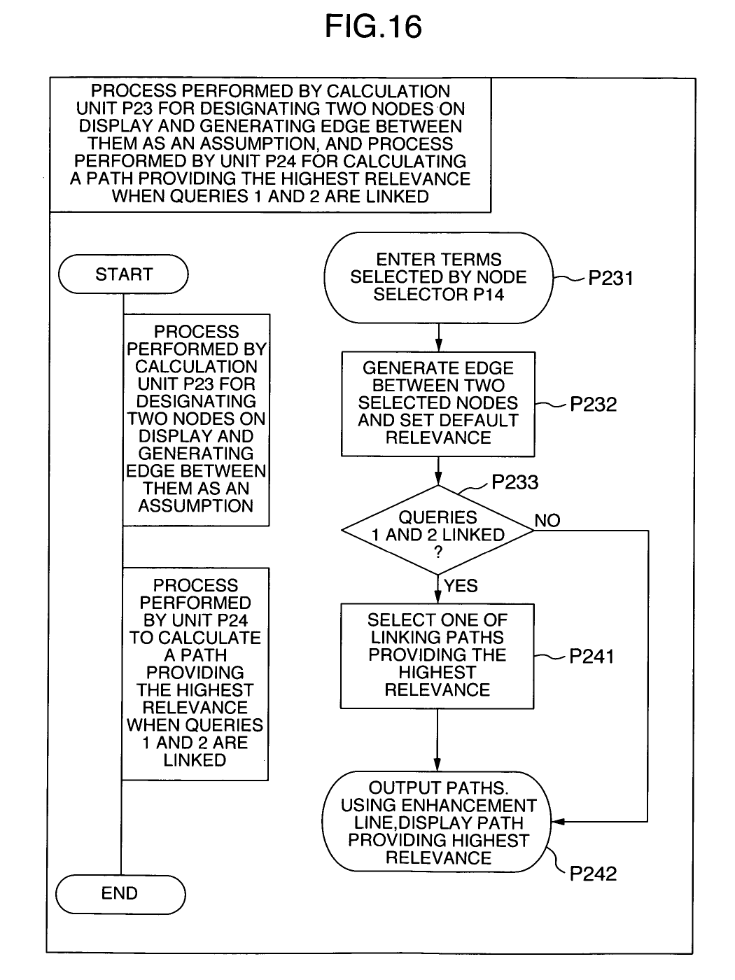

FIG. 16 is a detailed diagram showing the process performed by the calculation unit P23 that designates two nodes on the display and generates an edge between them as an assumption, and the process performed by the calculation unit P12 that calculates a path providing the highest relevance when the queries 1 and 2 are coupled.

First, a term selected by the node selector P14 is entered (P231). Then, an edge is generated between two selected nodes, and a default relevance, for example, is set as the relevance of the edge (P232). Thereafter, a check is performed to determine whether the queries 1 and 2, including the newly generated path, have been linked together (P233). When the queries 1 and 2 have not yet been linked, a path is output, and the process is terminated. When the queries 1 and 2 have been coupled, a path providing the highest relevance is selected (P241), and output. The path providing the highest relevance is displayed by using an enhancement line (P242). In this embodiment, an example wherein the two selected nodes are linked directly by a hypothetical edge is shown. However, the same method can be applied for an example wherein several nodes intervene between the two nodes.

It should be further understood by those skilled in the art that although the foregoing description has been made on embodiments of the invention, the invention is not limited thereto and various changes and modifications may be made without departing from the spirit of the invention and the scope of the appended claims.

1. A search system comprising:
a first input device for designating a first query belonging to a first category;
a second input device for designating a second query belonging to a second category;
a third input device for designating a search condition;
a data storage unit for storing, in a table, multiple sets of relevances between terms belonging to a third category, including the first category and the second category;
a first unit for employing the table stored in the data storage unit to search for terms that are correlated, based on the chain of relevancy of the first query and the second query, and edges that represent a relation of the terms, and for outputting the edges that represent correlations between multiple nodes and the terms, while the nodes are employed as the terms, and displaying the edges on a screen;
a second unit for selecting a predetermined node from among the multiple nodes;
a third unit for employing the table stored in the data storage unit to search, under the search condition, for terms relevant to the selected node and for outputting edges that represent relevancy with terms and new nodes; and
a fourth unit for displaying, on the screen, the new nodes and the edges that are output.

2. A search system according to claim 1, wherein the third input device includes: a path count entry portion for designating the number of paths,
wherein the third unit employs the table stored in the data storage unit to search for edges and nodes that can be reached by following a designated number of paths leading from the selected node, and outputs, as new nodes and edges, the nodes and edges that are found.

3. A search system according to claim 1, wherein the third input device includes a dominant concept display entry portion;
wherein a dominant concept table in which relations between terms and terms at a hierarchically higher level are stored in the data storage unit; and
wherein, when a dominant concept is entered in the dominant concept entry portion, the third unit employs the dominant concept table to output, as the new node, a term at a higher rank than a term obtained by the search.

4. A search system according to claim 1, wherein the third input device includes a relevant term count entry portion for designating the number of relevant terms; and
wherein the third unit employs the table stored in the data storage unit to search for terms acutely relevant to the selected node, in the number designated for the relevant term count entry portion, and to search for edges that link nodes, and to define the acutely relevant terms as new nodes and to output the new nodes and the edges that link nodes.

5. A search system according to claim 1, wherein the third input device includes a relevant term count entry portion, for designating the number of relevant terms, and a relevant document count entry portion, for designating the number of relevant documents;
wherein the third unit includes
(1) a fourth unit for searching for documents acutely relevant to the selected node, in a number designated in the relevant document count entry portion, by employing a term-document index that includes data indicating how many times which term is included in which document, and
(2) a fifth unit for examining the designated number of documents obtained by the search to find terms, in a number designated in the relevant term count entry portion, by using a document-term index that includes data indicating how many times which document includes which term; and
wherein, based on the table stored in the data storage unit, the third unit searches for edges that link the terms and defines the terms that are found as new nodes, and outputs the new nodes and edges.

6. A search system according to claim 1, wherein, at the least, either the first or the second query is a plural query.

7. A search system according to claim 1, wherein the fourth unit connects and displays, using an enhancement line, a route that extends from the first query to the second query and that provides the highest relevance between the terms.

8. A search system according to claim 1, wherein the first category represents one of a disease name, a symptom, a protein name, a gene name, a compound name and a gene/protein function, and the second category represents one of a compound name, a protein name and a gene name.

9. A search system according to claim 1, the relevant terms of which are extracted in accordance with either a co-occurrence between terms or a phase pattern.

10. A search system according to claim 1, further comprising:
a synonym dictionary used to normalize the first query and the second query.

11. A search system comprising:
a first input device for designating a first query belonging to a first category;
a second input device for designating a second query belonging to a second category;
a data storage unit for storing, in a table, multiple sets of relevances between terms belonging to a third category, including the first category and the second category;
a first unit for employing the table stored in the data storage unit to search for terms that are correlated, based on the chain of relevancy of the first query and the second query, and edges that represent a relation of the terms, and for outputting the edges that represent correlations between multiple nodes and the terms, while employing the nodes as the terms and displaying the edges on a screen;
a second unit for selecting two nodes from among the multiple nodes;
a third unit for coupling the two selected nodes as an assumption;
a fourth unit for selecting a path providing the highest relevance from among paths that link the first query and the second query; and
a fifth unit for outputting the selected path and displaying the path on a screen.

12. A search system according to claim 11, wherein the fifth unit uses highlighting to display the selected path on the screen.

13. A search method, which employs a search system including a first input device for designating a first query belonging to a first category, a second input device for designating a second query belonging to a second category, and a data storage unit for storing, in a table, multiple sets of relevances between terms belonging to a third category, including the first category and the second category, comprising the steps of:
entering the first query in the first input device;
entering the second query in the second input device;
employing the table stored in the data storage unit to perform a first search to find terms that are correlated, based on the chain of relevancy of the first query and the second query, and edges that represent a relation of the terms;
outputting the results obtained by the first search as edges that represent correlations between multiple nodes and terms;
selecting a predetermined node from among the multiple nodes;
designating a search condition for the predetermined selected node;
employing the table stored in the data storage unit to perform a second search, under the search condition, to find terms correlated with the predetermined selected node; and
outputting the results obtained by the second search as edges representing correlations between new nodes and the terms, and displaying the results on a screen.
